(19) United States
(12) Patent Application Publication
(10) Pub. No.: US 2023/0257321 A1
(43) Pub. Date: Aug. 17, 2023

(54) LOW DUST SEED FLOW LUBRICANT COMPOSITIONS AND METHODS

(71) Applicant: Kannar Earth Science, Ltd., Lawrenceville, GA (US)

(72) Inventors: Samuel L. CLOETE, Suwanee, GA (US); Heather LEWIS, Duluth, GA (US)

(21) Appl. No.: 18/168,165

(22) Filed: Feb. 13, 2023

Related U.S. Application Data
(60) Provisional application No. 63/310,244, filed on Feb. 15, 2022.

(51) Int. Cl. C05G 3/20; C05F 11/08; A01C 1/06

(52) U.S. Cl. CPC C05G 3/20; C05F 11/08; A01C 1/06

(57) ABSTRACT

Compositions and methods are provided for seed treatment to improve seed appearance, flowability, and plantability while minimizing fugitive dust. Inclusion of a water miscible non-solvent in the seed treatment composition is found to minimize fugitive dust. Further advantages of the seed treatment compositions include that they are non-toxic and microplastic free, reduce drying time for liquid treated seed, and have an increased shelf life relative to seed lubricant compositions based on plant oils that can become rancid over time.

### CROSS-REFERENCE TO RELATED APPLICATION

This application claims priority to United States Provisional Patent Application No. 63/310,244 filed on Feb. 15, 2022, the entire contents of which are incorporated by reference herein.

### TECHNICAL FIELD

The present invention relates to compositions for use as dry seed treatments that improve seed appearance and flowability, while minimizing fugitive dust during application.

### BACKGROUND

Agricultural seed is often treated with biological agents and/or pesticides that protect the seeds from pests and disease. Seeding equipment such as planters and seed drills have evolved to the point that seeds can be singulated and planted precisely with respect to depth, spacing, population, and seed orientation within the soil. However, treated seed tends to flow and handle differently than untreated seed. Typically, treated seed does not flow as well through seeding/planting devices and residue can build up on equipment surfaces. As a result, seed lubricants are added to seed treatment formulations to improve seed flow and reduce wear on seeding equipment.

While powdered lubricants had been traditionally applied by the farmer/grower in the field at the time of planting the seed, commercial seed operators have begun adding the powdered lubricants immediately following liquid seed treatment application. This commercial application has been made feasible by the use of additives such as very finely ground mica coated with a lubricating and cosmetic agent. The powder lubricant can be effectively applied in either continuous flow or batch seed treating systems, immediately following liquid treatment application, and while the seed is still within the applicator. However, the operators of seed treating equipment who apply the dry lubricants must now contend with the fugitive dust.

Fugitive dust is a workplace hazard, which without mitigation or precautions causes serious health and safety ramifications for workers. For example, seed flow lubricants can tend to abrade the surfaces of the seeds creating seed dust. Dust from untreated seeds primarily consists of naturally occurring components of the seed such as chaff and the seed hull, while dust from treated seeds can also include components of the seed treatment (e.g., fungicide, insecticide, and the like). Of particular concern is particulate matter air pollution comprised of fine inhalable particles, with diameters that are generally 2.5 micrometers and smaller. These particles are small enough to get deep into workers lungs. Fine inhalable particles also cause visibility issues.

Thus, there is an unmet need for seed flow lubricant compositions that reduce fugitive dust.

### SUMMARY

In one embodiment of the invention, a composition is provided for seed treatment including: (i) about 50-95% by weight titanium dioxide coated in mica or about 50-95% by weight silica, or combinations thereof; (ii) optionally, about 10-30% of a flow agent, and (iii) about 5-30% by weight of a water miscible substance that is a non-solvent of components (i) and (ii).

In other aspects of the invention, a method is provided for seed treatment including: contacting seed with a composition including: (i) about 50-95% by weight titanium dioxide coated in mica or about 50-95% by weight silica, or combinations thereof; (ii) optionally, about 10-30% of a flow agent, and (iii) about 5-30% by weight of a water miscible substance that is a non-solvent of components (i) and (ii). The seed can be mixed, vibrated, or agitated during the contacting. The contacting can occur in a seed planter box or prior to adding the seed to a seed planter box. In one embodiment, the seed has been treated with one or more liquid pesticides.

In one instance of the invention, a seed coated with a composition is provided. The composition coating the seed includes: (i) about 50-95% by weight titanium dioxide coated in mica or about 50-95% by weight silica, or combinations thereof; optionally, about 10-30% of a flow agent; and (iii) about 5-30% by weight of a water miscible substance that is a non-solvent of components (i) and (ii).

The composition and the seed can be in a weight ratio from about 0.0001:1 to about 0.5:1. The composition can be in an amount ranging from about 0.5 ounces per 100 pounds of seed to about 5 ounces per 100 pounds of seed.

In the methods and coated seed of the invention, the seed can include one or more nutrients, plant growth promoters, or pesticides. In another embodiment of the invention, a method is provided for making a composition seed treatment, the method including combining a water miscible substance in an amount of about 5-30% by weight of the composition with: (i) about 50-95% by weight titanium dioxide coated in mica or about 50-95% by weight silica, or combinations thereof; and (ii) optionally, about 10-30% of a flow agent. In the method, the water miscible substance is a non-solvent of components (i) and (ii), and any combinations thereof. The component (i) or a mixture of the components (i) and (ii) can be mixed, vibrated, or agitated during the combining.

In the compositions, methods, and coated seeds of the invention, the water miscible non-solvent in the composition can include, but is not limited to, propylene glycol, ethylene glycol, glycerol, glycerin, or propanediol, or combinations thereof.

The flow agent in the composition can include a cellulose-based polymer, hydroxyethyl cellulose (HEC), hydroxyethyl propyl methyl cellulose (HPMC), quillaja extract, xanthan gum, or yucca extract, or combinations thereof. In another instance, the flow agent can include protein powder, plant protein powder, talc, or graphite, or combinations thereof.

In some cases, the titanium dioxide coated in mica can include about 50% to about 80% mica and about 25% to about 50% titanium dioxide. In one embodiment, the composition can include titanium dioxide coated in mica, plant protein powder, and propylene glycol.

In the compositions, methods, and coated seeds of the invention, the composition can include one or more nutrients, plant growth promoters, or microbial agents for benefiting plant growth and/or health.

In the compositions, methods, and coated seeds of the invention, the seed can include, but is not limited to, seed from: corn, legume plants, cereal, grass, cotton, oil, or vegetable plants.

### BRIEF DESCRIPTION OF THE DRAWINGS

FIG. 1A is a photograph of soybean seed treated with a liquid chemical treatment alone.

FIG. 1B is a photograph of soybean seed treated with a product containing a 4:1 ratio of titanium dioxide coated with mica to DUST (soy protein powder and soy lecithin).

FIG. 1C is a photograph of soybean seed treated with a blend of the product containing a 4:1 ratio of titanium dioxide coated with mica to DUST, with the addition of 10% water miscible non-solvent propylene glycol.

### DETAILED DESCRIPTION

For the purposes of promoting an understanding of the principles of the present disclosure, reference will now be made to preferred embodiments and specific language will be used to describe the same. It will nevertheless be understood that no limitation of the scope of the disclosure is thereby intended, such alteration and further modifications of the disclosure as illustrated herein, being contemplated as would normally occur to one skilled in the art to which the disclosure relates.

Following long-standing patent law convention, the terms “a,” “an,” and “the” refer to “one or more” when used in this application, including the claims. Thus, for example, reference to “a composition” includes a plurality of compositions, unless the context clearly is to the contrary, and so forth.

Throughout this specification and the claims, the terms “comprise,” “comprises,” and “comprising” are used in a non-exclusive sense, except where the context requires otherwise. Likewise, the terms “having” and “including” and their grammatical variants are intended to be non-limiting, such that recitation of items in a list is not to the exclusion of other like items that can be substituted or added to the listed items.

For the purposes of this specification and claims, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range. In addition, as used herein, the term “about”, when referring to a value can encompass variations of, in some embodiments +/−20%, in some embodiments+/−10%, in some embodiments+/−5%, in some embodiments+/−1%, in some embodiments+/−0.5%, and in some embodiments+/−0.1%, from the specified amount, as such variations are appropriate in the disclosed compositions and methods. Where particular values are described in the application and claims, unless otherwise stated, the term “about” meaning within an acceptable error range for the particular value should be assumed.

In various embodiments, the present invention provides seed lubricant compositions and methods for increasing seed flowability and reducing drying time for liquid treated seed while minimizing fugitive dust during application of the lubricant. The seed lubricant compositions of the invention include a water miscible substance that is a non-solvent of the other dry components in the composition including: (i) about 50-95% by weight titanium dioxide coated in mica or about 50-95% by weight silica, or combinations thereof; optionally, about 10-30% of a flow agent; and (iii) about 5-30% by weight of a water miscible substance that is a non-solvent of components (i) and (ii). Inclusion of such a water miscible non-solvent was found to be effective in minimizing the formation of fugitive dust without disrupting the intended performance of the lubricant in terms of seed flowability and reducing dry time for liquid treated seed.

For the purposes of the specification and claims, what is meant by the term “water miscible substance” is a substance that is capable of mixing with water in any ratio without separation of two phases. The water miscible substance and water can dissolve in each other in all proportions. What is meant by the term “non-solvent” is that it is not capable of dissolving either component (i) or (ii) of the composition.

In addition, the seed treatment compositions of the invention are non-toxic and microplastic free and have the added advantage of increasing shelf life relative to seed lubricant compositions containing plant-based oils that can become rancid. The drying and flowability aid of the compositions of the invention assist in the treating, bagging, and planting of seed while also delivering shine and sheen.

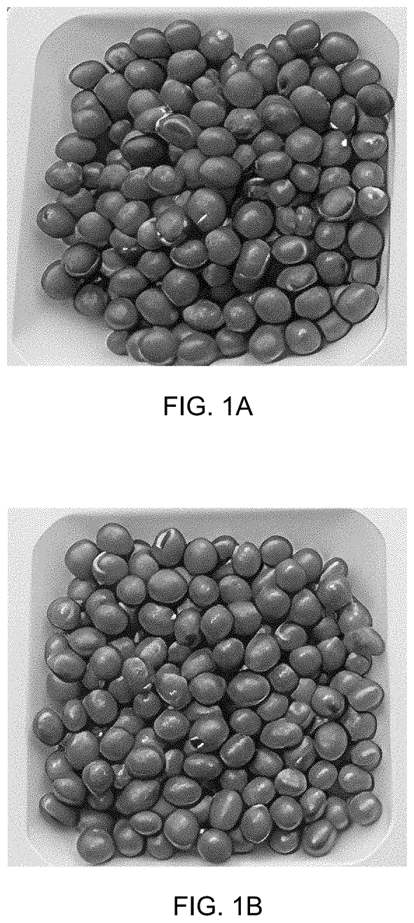

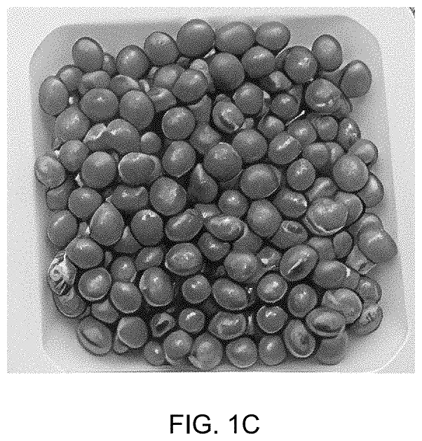

Examples of the compositions and methods of the present invention were developed and tested as described in the Examples herein below. Example 1 describes various methods for adding a water miscible non-solvent to a dry seed lubricant product containing 80% titanium dioxide coated with mica and 20% soy protein powder and soy lecithin. The results in Example 2 demonstrate that inclusion of a water miscible non-solvent in various ratios in dry seed lubricant formulations including titanium dioxide coated with mica and silica can reduce generation of fugitive dust. The experiments described in Example 3 and shown in FIGS. 1A-1C demonstrate that treatment of soybean seed with the seed treatment formulations containing a water miscible non-solvent results in seed with the desired shine and sheen. Specifically, seed treated with commercially available powder lubricant compositions does not look discernably different from seeds treated with the same compositions containing 5-30% added water miscible non-solvent. The results in Example 4 demonstrate that seed treated with the compositions containing a water miscible non-solvent have increased flowability in cox funnels relative to untreated seed and can perform as well as a commercially available seed flow lubricant formulation. The seed treatment compositions having a water miscible non-solvent between 5% and 30% by weight of the composition were more resistant to generating dust. Unexpectedly, inclusion of the water miscible non-solvent did not hinder the drying, flowability, or appearance of the seed regardless of seed shape or size.

The water miscible non-solvents of the invention include any water miscible substance that is a non-solvent of the other components in the composition. In one embodiment, the water miscible non solvent includes, but is not limited to, propylene glycol, ethylene glycol, glycerol, glycerin, or propanediol, or combinations thereof.

In the compositions of the invention, the flow agents can include, but are not limited to, a cellulose-based polymer, hydroxyethyl cellulose (HEC), hydroxyethyl propyl methyl cellulose (HPMC), quillaja extract, xanthan gum, or yucca extract, or combinations thereof. In another instance, the flow agent can include protein powder, plant protein powder, talc, or graphite, or combinations thereof.

In one embodiment, the titanium dioxide coated in mica comprises about 50% to about 80% mica and about 25% to about 50% titanium dioxide.

In another embodiment, the composition includes titanium dioxide coated in mica, plant protein powder, and propylene glycol.

The seed treatment compositions of the invention can further include one or more nutrients, plant growth promoters, or microbial agents for benefiting plant growth and/or health. Microbial agents for benefiting plant growth and/or health can include any beneficial microbe and can include, for example, but are not limited to, one or more of Beauveria bassiana, Aspergillus niger, Paecilomyces lilacinus, Trichoderma harzianum, T. viride, T. viride, T. polysporum, Pochonia chlamydosporia, Pasteuria penetrans, Pseudomonas flurorescens, P. putida, Bacillus firmus, B. thuringiensis, B. velezensis, B. megaterium, B. mojavensis, B. subtilis, Bacillus licheniformis, B. amyloliquefaciens, and B. coagulans, B. siamensis, B. paralicheniformis, B. haynesii, B. sonorensis, B. swezeyi, B. atrophaeus, B. pumilus, and Azospirilla brasilense.

In one instance, a method is provided for making a composition seed treatment, the method including combining a water miscible substance in an amount of about 5-30% by weight of the composition with: (i) about 50-95% by weight titanium dioxide coated in mica or about 50-95% by weight silica, or combinations thereof; and (ii) optionally, about 10-30% of a flow agent. In the method, the water miscible substance is a non-solvent of components (i) and (ii), and any combinations thereof. The component (i) or a mixture of the components (i) and (ii) can be mixed, vibrated, or agitated during the combining.

In one embodiment of the invention, a method is provided for seed treatment that includes a step of contacting the seed with a composition of the invention.

In the method, the seed can be mixed, vibrated, or agitated during the contacting.

In the method, the seed can further include one or more nutrients, plant growth promoters, or pesticides. For example, the seed can be treated with a liquid treatment containing one or more nutrients, plant growth promoters, fertilizers, pesticides, insecticides, or fungicides prior to being contacted with a composition of the invention. In this case, contacting the seed with the composition can decrease the amount of time needed for the seed to dry after the liquid treatment.

In one embodiment of the method, the composition of the invention being contacted with the seed further includes one or more nutrients, plant growth promoters, or microbial agents for benefiting plant growth and/or health.

The composition can be contacted with the seed in a weight ratio from about 0.0001:1 to about 0.5:1. In one embodiment, the composition is contacted with the seed in an amount ranging from about 0.5 ounces per 100 pounds of seed to about 5 ounces per 100 pounds of seed.

The contacting of the seed with the composition can occur in a seed planter box, rotary seed treater, continuous seed treater, bowl treater, or any other seed treatment equipment. The seed can be contacted with the composition in a planter box just in time for planting or, alternatively, the seed can be contacted with the composition well in advance of the time of planting and stored for a period of time prior to planting. In some embodiments, the compositions of the invention are designed to optimize easy flow through commonly used seed treatment equipment.

In one embodiment, the lubricant compositions are compatible with seed treatment equipment that does not utilize mesh screens such as, for example, SedPell equipment.

In the compositions and methods of the invention, the seed can be seed from any plant. In one embodiment, the seed is from corn, legume plants, cereal, grass, cotton, oil, or vegetable plants.

The seed coated with the composition can further include one or more nutrients, plant growth promoters, or pesticides. For example, in some cases the seed can be treated with a liquid treatment containing one or more nutrients, plant growth promoters, fertilizers, insecticides, or fungicides prior to being coated with the composition.

In one embodiment, the composition coated on the seed can further include one or more nutrients, plant growth promoters, or microbial agents for benefiting plant growth and/or health.

Accordingly, while the compositions and methods have been described in reference to specific embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the elements and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

### EXAMPLES

### Example 1

### Method for Adding Water Miscible Non-Solvents

To determine the best way to add a water miscible non-solvent to a dry seed treatment formulation, the same ratio of dry ingredients to water miscible non-solvent was mixed using a variety of techniques. The blend of dry ingredients used was 80% Titanium Dioxide coated with Mica (Sun Chemical, Parsippany N.J.) and 20% DUST (Low Mu Tech, Calamus, Iowa) containing soy protein powder and soy lecithin. The water miscible non-solvent used for this experiment was propylene glycol. The same amount of dry ingredient blend was put into a clean, dry plastic container to test each mixing technique individually as described below.
Adding the propylene glycol all at once to one spot in the dry formulation and then mixing resulted in clumping of the dry ingredients.
Adding the propylene glycol all at once by pouring it throughout the top of the container holding the dry formulation and then mixing resulted in clumping of the dry ingredients.
Adding the propylene glycol incrementally to one area of the dry formulation and then mixing in between each added increment resulted in some clumping, but not as much as adding the propylene glycol all at once to one spot or adding it all at once throughout the top of the container prior to mixing.
Adding the propylene glycol in increments to multiple areas of the dry formulation followed by mixing after each added increment resulted in about the same amount of clumping as adding the Propylene glycol in increments to one area and mixing after each added increment.
Adding the propylene glycol slowly while mixing the dry ingredients resulted in the least clumping and provided the most homogeneous blend.

It was determined that the best method for adding the water miscible non-solvent to the dry ingredients was to add it slowly while the dry ingredients were being mixed. This is the method that was used to test the efficacy of various water miscible non-solvents in terms of minimizing fugitive dust as well as improving seed flowability and appearance as described herein below.

### Example 2

### Addition of Water Miscible Non-Solvent Reduces Dust

The same dry blend of ingredients as described above in Example 1 was used to test the water miscible non-solvents, propylene glycol, ethylene glycol and glycerin. This was to see if one would work more effectively than the other at curtailing any airborne particles. For this, the blend of dry ingredients was combined with the water miscible non-solvent as described below:
Adding propylene glycol to the dry blend at an ambient temperature, approximately 25 C or 77 F, lead to less fugitive dust and a relatively homogeneous blend.
Adding ethylene glycol to the dry blend at an ambient temperature, approximately 25 C or 77 F, lead to less fugitive dust and a mostly homogeneous blend, but there was more clumping than with the propylene glycol and therefore more mixing was needed. After more mixing, the blend using glycerin had approximately the same amount of clumping as the propylene glycol.
Adding glycerin to the dry blend at an ambient temperature, approximately 25 C or 77 F, lead to less fugitive dust and a somewhat homogeneous blend, but there was more clumping than with the propylene glycol and therefore more mixing was needed. After more mixing, the blend using glycerin had approximately the same amount of clumping as the propylene glycol.

It was determined that additional tests would be completed using propylene glycol. At room/ambient temperature, glycerin is thicker than propylene glycol. This could be why the entries using glycerin seemed slightly dumpier. Applying a water miscible non-solvent such as glycerin with heat would aid in the flowability of the product, making the end product not as clumpy. Propylene glycol is more water-like at ambient temperatures.

Multiple dry ingredient formulations were blended for testing with propylene glycol as shown below (labeled as Entries 1-9). These entries varied in the content and ratio of ingredients to determine the optimal ratio of ingredients for minimizing dust while maximizing seed fluency and appearance. The dry ingredient titanium dioxide coated in mica was used in the range from about 50% to about 80% mica and from about 25% to about 50% titanium dioxide. Dry ingredient titanium dioxide coated in mica was from Sun Chemical, Parsippany, N.J. and silica was from AL2 Chem Specialties. Water miscible non-solvent, propylene glycol, was from Brenntag, Durham, N.C. The entries were as follows:

Entry 1

| | |
|---|---|
| Titanium dioxide coated in mica | 100% |

Entry 2

| | |
|---|---|
| Titanium dioxide coated in mica | 99% |
| Propylene glycol | 1% |

Entry 3

| | |
|---|---|
| Titanium dioxide coated in mica | 95% |
| Propylene glycol | 5% |

Entry 4

| | |
|---|---|
| Titanium dioxide coated in mica | 90% |
| Propylene glycol | 10% |

Entry 5

| | |
|---|---|
| Titanium dioxide coated in mica | 80% |
| Propylene glycol | 20% |

Entry 6

| | |
|---|---|
| Titanium dioxide coated in mica | 70% |
| Propylene glycol | 30% |

Entry 7

| | |
|---|---|
| Silica | 100% |

Entry 8

| | |
|---|---|
| Propylene glycol | 1% |
| Silica | 99% |

Entry 9

| | |
|---|---|
| Propylene glycol | 5% |
| Silica | 95% |

Entry 10

| | |
|---|---|
| Propylene glycol | 10% |
| Silica | 90% |

Entry 11

| | |
|---|---|
| Propylene Glycol | 20% |
| Silica | 80% |

Entry 12

| | |
|---|---|
| Propylene Glycol | 30% |
| Silica | 70% |

One pound of each entry was blended by hand in a plastic container. One handful of each entry was picked up and dropped back into its designated container to visually check the dustiness of each entry. The results for each of the entries are described below.

Entry 1—had a lot of dust

Entry 2—had a lot of dust

Entry 3—had a lesser amount of dust, but still more than desired

Entry 4—had minimal dust

Entry 5—had minimal dust

Entry 6—had minimal dust

Entry 7—had a lot of dust

Entry 8—had a lot of dust

Entry 9—had a lesser amount of dust, but still more than desired

Entry 10—had minimal dust

Entry 11—had minimal dust

Entry 12—had minimal dust

### Example 3

### Appearance of Soybean Seed Treated with Test Lubricant Formulations

Treatment of soybean seed with the test formulations was performed as follows. A first batch of soybean seed was treated with a commercially available liquid chemical treatment, KAN-SOY 252 ST, according to manufacturer's label (Kannar Earth Science, Lawrenceville Ga.). This batch did not have any dry seed finishers added in order to compare the shine and sheen of the seed with subsequent entries that had dry seed finishers added. For all other entries, after liquid chemical treatment, the batch of soybean seed was treated with one of the test formulation entries at a rate of 1.600 Dry Oz formulation/CWT (CWT represents 100 pounds of seed). Each batch of seed was treated with a test entry after the same interval of elapsed time since liquid treatment (i.e., 1 minute). This same procedure was repeated for each of the test formulations. In addition, a commercially available formulation of 4:1 Titanium Dioxide coated with Mica (Sun Chemical, Parsippany N.J.) and DUST (Low Mu Tech, Calamus, Iowa) was included in the experiment as Entry 9 to enable comparison of treated seed flowability and appearance. The DUST product contains a mixture of soy protein powder and soy lecithin. A description of the formulation entries is provided below.

Entry 13—4:1 Titanium Dioxide coated with Mica to DUST

Entry 14—4:1 Titanium Dioxide coated with Mica to DUST+5% water miscible non-solvent propylene glycol

Entry 15—4:1 Titanium Dioxide coated with Mica to DUST+10% water miscible non-solvent propylene glycol

Entry 16—4:1 Titanium Dioxide coated with Mica to DUST+20% water miscible non-solvent propylene glycol

Entry 17—Seed treated with liquid chemical treatment alone

After treating the soybean seed with each of the entries as described above, it was noted that the length of time required for the seed to dry completely was reduced for Entries 9 and 10 as compared to Entry 11 where the seed was not treated with a dry lubricant formulation. In addition, there was no discernable difference in drying time for seed treated with the entry that included propylene glycol as compared to those without propylene glycol. These results demonstrate that the dry seed lubricant formulations aid in the drying of the seed after liquid treatment.

It was determined that entry 15, with added 10% water miscible non-solvent, and entry 13, without added water miscible non-solvent, did not have a noticeably different appearance (compare FIGS. 1B and 1C for entries 13 and 15, respectively). In addition, entries 13 and 15 delivered the desired shine and sheen when compared to the soybean seed not treated with a lubricant formulation, entry 17, as shown in FIG. 1A. Similar results were observed for entries 14 and 16, containing 5% or 20% added polypropylene glycol, respectively. Specifically, as described above, there was no discernable difference in appearance between these entries that included the water miscible non-solvent and entry 13 that did not.

### Example 4

### Flowability of Seed Treated with Test Lubricant Formulations

In addition to an enhanced appearance of the seed, the lubricant formulation is meant to aid in the flowability of the seed. Thus, treated seed from Example 3 was put through flowability funnels (cox funnels) to determine rate of seed flow. This is designed to measure how easily treated seed would travel through commercial seed treatment equipment. Below is a description of the various trials performed to measure flow rate for each of the seed batches from Example 3 above.

Entry 13 (4:1 Titanium Dioxide coated with Mica to DUST) vs Entry 17 (No lubricant formulation)
Result: Entry 13 consistently flowed through the funnels faster.

Entry 13 (4:1 Titanium Dioxide coated with Mica to DUST) vs Entry 15 (4:1 Titanium Dioxide coated with Mica to DUST+10% water miscible non-solvent)
Result: Entries flowed through the funnels at approximately the same rate.

Entry 15 (4:1 Titanium Dioxide coated with Mica to DUST+10% water miscible non-solvent) vs Entry 17 (No lubricant formulation)
Result: Entry 15 consistently flowed through the funnels faster.

It was verified that seed treated with 4:1 Titanium Dioxide coated with Mica to DUST flowed through the funnels faster than seed not treated with a lubricant. It was determined that seed treated with formulations that included 4:1 Titanium Dioxide coated with Mica to DUST and water miscible non-solvent were equally as good at increasing flowability as 4:1 Titanium Dioxide coated with Mica to DUST.

To verify that the lubricant formulations would retain their properties of enhancing seed appearance and flowability on a larger seed type that is not round, peanut seed was treated with the test lubricants. Specifically, peanut seed was first treated with a standard liquid peanut seed treatment, Rancona VPL, according to manufacturer label (UPL, King of Prussia Pa.). The peanut seed was then treated with formulation Entry 13 (4:1 Titanium Dioxide coated with Mica to DUST) and formulation Entry 15 at a rate of 2.000 Dry Oz/CWT at a consistent time interval after liquid treatment as similarly described above for soybean seed in Example 3. The treated peanut seed from both entries had enhanced shine. This confirmed that the findings from treating the soybean seed can be carried over to other seed types as well.

In conclusion, the lubricant formulations having a water miscible non-solvent between 5 and 30% by weight were more resistant to generating dust. There was visibly less dust in the air in for the entries containing a water miscible non-solvent. In addition, water miscible non-solvent propylene glycol did not hinder the drying, flowability, or appearance of the seed regardless of seed shape or size.

What is claimed is:

1. A composition for seed treatment comprising:
i. about 50-95% by weight titanium dioxide coated in mica or about 50-95% by weight silica, or combinations thereof;
ii. optionally, about 10-30% of a flow agent; and
iii. about 5-30% by weight of a water miscible substance that is a non-solvent of components (i) and (ii).

2. The composition of claim 1, wherein the water miscible non-solvent comprises propylene glycol, ethylene glycol, glycerol, glycerin, or propanediol, or combinations thereof.

3. The composition of claim 1, wherein the flow agent comprises a cellulose-based polymer, hydroxyethyl cellulose (HEC), hydroxyethyl propyl methyl cellulose (HPMC), quillaja extract, xanthan gum, or yucca extract, or combinations thereof.

4. The composition of claim 1, wherein the flow agent comprises protein powder, plant protein powder, talc, or graphite, or combinations thereof.

5. The composition of claim 1, wherein the titanium dioxide coated in mica comprises about 50% to about 80% mica and about 25% to about 50% titanium dioxide.

6. The composition of claim 1, comprising titanium dioxide coated in mica, plant protein powder, and propylene glycol.

7. The composition of claim 1, wherein the composition further comprises one or more nutrients, plant growth promoters, or microbial agents for benefiting plant growth and/or health.

8. A method for seed treatment comprising:
contacting seed with a composition comprising:
i. about 50-95% by weight titanium dioxide coated in mica or about 50-95% by weight silica, or combinations thereof;
ii. optionally, about 10-30% of a flow agent; and
iii. about 5-30% by weight of a water miscible substance that is a non-solvent of components (i) and (ii).

9. The method of claim 8, wherein the water miscible non-solvent comprises propylene glycol, ethylene glycol, glycerol, glycerin, or propanediol, or combinations thereof.

10. The method of claim 8, wherein the composition comprises titanium dioxide coated in mica, plant protein powder, and propylene glycol.

11. The method of claim 8, wherein the seed is being mixed, vibrated, or agitated during the contacting.

12. The method of claim 8, wherein the contacting occurs in a seed planter box or prior to adding the seed to a seed planter box.

13. The method of claim 8, wherein the composition and seed are in a weight ratio from about 0.0001:1 to about 0.5:1.

14. The method of claim 8, wherein the composition and the seed are in an amount ranging from about 0.5 ounces per 100 pounds of seed to about 5 ounces per 100 pounds of seed.

15. The method of claim 8, wherein the seed comprises seed from: corn, legume plants, cereal, grass, cotton, oil, or vegetable plants.

16. The method of claim 8, wherein the seed has been treated with one or more liquid pesticides.

17. The method of claim 8, wherein the composition further comprises one or more nutrients, plant growth promoters, or microbial agents for benefiting plant growth and/or health.

18. A seed coated with a composition, the composition comprising:
i. about 50-95% by weight titanium dioxide coated in mica or about 50-95% by weight silica, or combinations thereof;
ii. optionally, about 10-30% of a flow agent; and
iii. about 5-30% by weight of a water miscible substance that is a non-solvent of components (i) and (ii).

19. The seed of claim 18, wherein the water miscible non-solvent comprises propylene glycol, ethylene glycol, glycerol, glycerin, or propanediol, or combinations thereof.

20. The seed of claim 18, wherein the titanium dioxide coated in mica comprises about 50% to about 80% mica and about 25% to about 50% titanium dioxide.

21. The seed of claim 18, wherein the composition further comprises one or more nutrients, plant growth promoters, or microbial agents, or combinations thereof, for benefiting plant growth and/or health.

22. The seed of claim 18, wherein the seed further comprises one or more nutrients, plant growth promoters, microbial agents, or pesticides, or combinations thereof, for benefiting plant growth and/or health.
